(19) United States
(12) Patent Application Publication
(10) Pub. No.: US 2018/0197168 A1
(43) Pub. Date: Jul. 12, 2018

(54) SYSTEM AND METHOD FOR CONDUCTING A TRANSACTION

(71) Applicant: MasterCard International Incorporated, Purchase, NY (US)

(72) Inventors: Driss Belemlih, Dubai (AE); Saad Khan, Dubai (AE); Omokehinde Adebanjo, Lagos (NG); Uwagbae Uzebu, Lagos (NG)

(21) Appl. No.: 15/846,668

(22) Filed: Dec. 19, 2017

(30) Foreign Application Priority Data
Dec. 22, 2016 (SG) 10201610774U

(51) Int. Cl. G06Q 20/26; G06Q 10/08

(52) U.S. Cl. CPC G06Q 20/26; G06Q 10/0833

(57) ABSTRACT

A system and method for conducting a transaction is provided. The method comprises receiving, at a courier module, a delivery order relating to a delivery of a product to a recipient by a courier service; and generating, by the courier module, a card-on-file mobile payment instruction for transmission to a payment module to complete the transaction based on: (i) a delivery status corresponding to an outcome of the delivery of the product to the recipient; and (ii) a payment status corresponding to an outcome of a cash payment for the product by the recipient to the courier service.

### CROSS REFERENCE TO RELATED APPLICATION

This application claims priority to Singapore Patent Application No. 10201610774U, filed on Dec. 22, 2016, entitled “System and Method for Conducting a Transaction”, which is incorporated by reference herein in its entirety.

### FIELD OF INVENTION

The present disclosure relates to systems and methods for conducting a transaction.

### BACKGROUND

Many consumers are using the internet to purchase their products because of the relative ease of making online transactions. This has led to significant increase in the number of online merchants and online transactions. In most cases, products purchased online are delivered to the consumer by a courier service.

Many consumers use payment cards to pay for their online transactions. However, there may be a lack of trust between consumers and merchants. One factor for the lack of trust is the issue of cybersecurity for online transactions. Theft of payment card information by hackers as well as the integrity of the merchant's website are common cybersecurity issues. Therefore, many consumers are reluctant to use their payment cards for such online transactions and instead prefer to pay in cash at the time of delivery. In addition, some consumers may not have payment cards and these consumers are not able to make purchases from online merchants that do not offer a cash-on-delivery option and require payment at the time of ordering.

Furthermore, many consumers do not wish to pay the merchants for online purchases until the consumers are satisfied with the delivered products. This is because the delivered products may not be identical to the products that they had bought online (e.g. wrong colour, wrong size etc.). The delivered products may also be defective (e.g. manufacturing defects or damage during delivery). By paying upfront for the purchased products, consumers face a tedious process to exchange their delivered products or to obtain a refund when such problems arise.

A need therefore exists to provide a method and system for conducting a transaction that seeks to address at least some of the above problems.

### SUMMARY

According to a first aspect, there is provided a method for conducting a transaction, comprising: receiving, at a courier module, a delivery order relating to a delivery of a product to a recipient by a courier service; and generating, by the courier module, a card-on-file mobile payment instruction for transmission to a payment module to complete the transaction based on: (i) a delivery status corresponding to an outcome of the delivery of the product to the recipient; and (ii) a payment status corresponding to an outcome of a cash payment for the product by the recipient to the courier service.

In an embodiment, the method may further comprise: (i) receiving, at a transaction module that is in communication with the courier module, a purchase request for the product; and (ii) generating, at the transaction module, the delivery order based on the purchase request.

In an embodiment, the card-on-file mobile payment instruction may comprise a price of the product and a merchant associated with the product.

In an embodiment, the purchase request may comprise one or more of: a description of the product, the price of the product, the merchant associated with the product and a cash-on-delivery payment option.

In an embodiment, the delivery status may comprise confirmation, by the recipient, of a successful or unsuccessful delivery of the product to the recipient.

In an embodiment, the payment status may comprise confirmation, by the courier service, of a successful or unsuccessful cash payment of the product by the recipient.

In an embodiment, the card-on-file mobile payment instruction to complete the transaction may be transmitted to the payment module on a condition that: (i) the delivery status comprises confirmation of the successful delivery of the product to the recipient; and (ii) the payment status comprises confirmation of the successful cash payment of the product by the recipient.

In an embodiment, an instruction to cancel the transaction may be transmitted to the payment module on a condition that: (i) the delivery status comprises confirmation of the unsuccessful delivery of the product to the recipient; or (ii) the payment status comprises confirmation of the unsuccessful cash payment of the product by the recipient.

In an embodiment, completing the transaction may comprise generating, by the payment module, an instruction to settle the transaction based on the price of the product.

In an embodiment, the method may further comprise: (i) generating a unique tracking identifier associated with the delivery of the product to the recipient; and (ii) transmitting, to a merchant module in communication with the courier module, a confirmation message on a condition that: (i) the delivery status comprises confirmation of a successful delivery of the product to the recipient; and (ii) the payment status comprises confirmation of a successful cash payment of the product by the recipient, wherein the confirmation message comprises the unique tracking identifier.

According to a second aspect, there is provided a system for conducting a transaction, comprising a courier module, the courier module comprising: at least one processor; and at least one memory including computer program code; the at least one memory and the computer program code configured to, with at least one processor, cause the courier module at least to: receive a delivery order relating to a delivery of a product to a recipient by a courier service; and generate a card-on-file mobile payment instruction for transmission to a payment module to complete the transaction based on: (i) a delivery status corresponding to an outcome of the delivery of the product to the recipient; and (ii) a payment status corresponding to an outcome of a cash payment for the product by the recipient to the courier service.

In embodiments, the system may further comprise a transaction module that is in communication with the courier module, wherein the transaction module is configured to: (i) receive a purchase request for a product; and (ii) generate the delivery order based on the purchase request.

In embodiments, the payment module may be configured to generate an instruction to settle the transaction based on the price of the product.

In embodiments, the transaction module may be further configured to generate a unique tracking identifier associated with the delivery of the product to the recipient, and wherein the courier module is further caused to transmit a confirmation message to a merchant module in communication with the courier module on a condition that: (i) the delivery status comprises confirmation of a successful delivery of the product to the recipient; and (ii) the payment status comprises confirmation of a successful cash payment of the product by the recipient, wherein the confirmation message comprises the unique tracking identifier.

### BRIEF DESCRIPTION OF THE DRAWINGS

Embodiments will be better understood and readily apparent to one of ordinary skill in the art from the following written description, by way of example only, and in conjunction with the drawings, in which:

FIG. 1 shows a flow chart illustrating a method for conducting a transaction according to an example embodiment.

FIG. 2 shows a schematic diagram illustrating the flow of information in a system for conducting a transaction, according to an example embodiment.

FIG. 3 shows a schematic diagram of a computer device/system suitable for realizing a courier module, according to an example embodiment.

FIG. 4 shows a schematic diagram illustrating the flow of information between various entities during a method for conducting a transaction, according to an example embodiment.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “identifying”, “authorizing”, “verifying” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

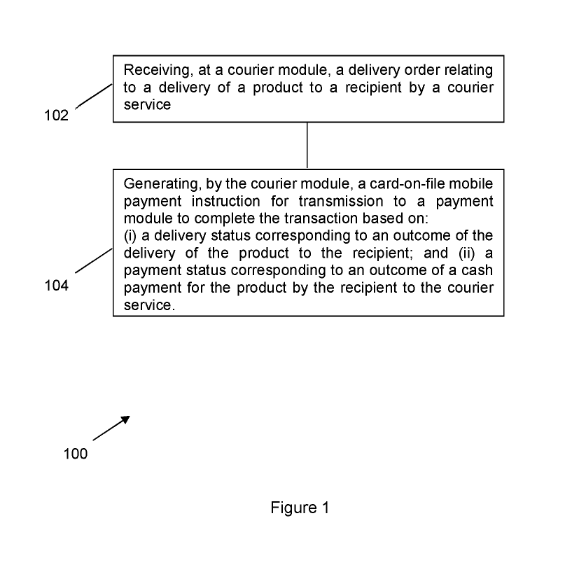

FIG. 1 shows a flow chart 100 illustrating a method for conducting a transaction according to an example embodiment. At step 102, a courier module receives a delivery order relating to a delivery of a product to a recipient by a courier service. At step 104, the courier module generates a card-on-file mobile payment instruction for transmission to a payment module to complete the transaction based on: (i) a delivery status corresponding to an outcome of the delivery of the product to the recipient, and (ii) a payment status corresponding to an outcome of a cash payment for the product by the recipient to the courier service. The card-on-file mobile payment instruction is associated with a mobile digital wallet application that is installed on the courier module for making card-on-file payment transactions. At the time of delivery, the recipient pays for the delivered product in cash to the courier service, similar to a traditional “cash-on-delivery” transaction.

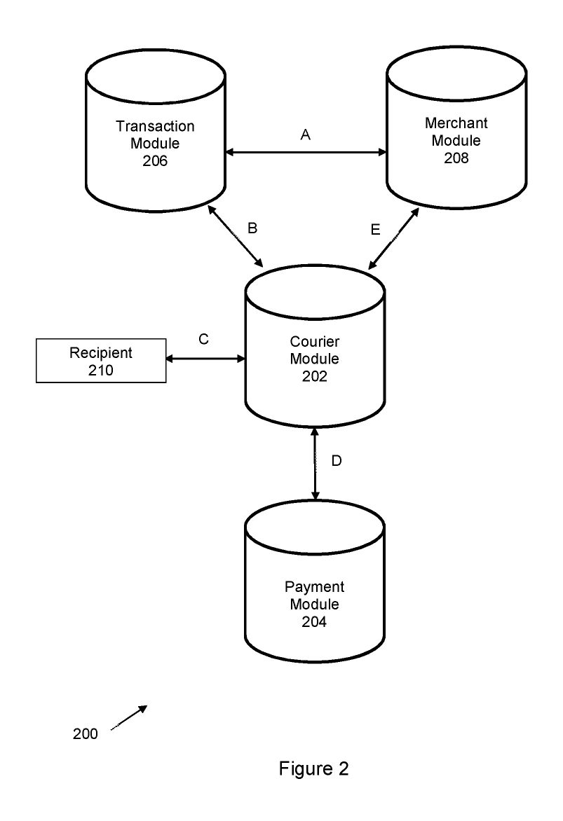

FIG. 2 shows a schematic diagram illustrating the flow of information in a system 200 for conducting a transaction, according to an example embodiment. The system 200 comprises a courier module 202, a payment module 204, a transaction module 206 and a merchant module 208. The courier module 202 is in communication with the payment module 204, the transaction module 206 and the merchant module 208. The courier module 202 may comprise at least one processor and at least one memory including computer program code. The at least one memory and the computer program code is configured to, with at least one processor, cause the courier module 202 at least to: receive a delivery order relating to a delivery of a product to a recipient by a courier service; and generate a card-on-file mobile payment instruction for transmission to the payment module 204 to complete the transaction based on: (i) a delivery status corresponding to an outcome of the delivery of the product to the recipient; and (ii) a payment status corresponding to an outcome of a cash payment for the product by the recipient to the courier service.

At step A of FIG. 2, the transaction module 206 receives a purchase request for the product from a merchant module 208. Where the context permits, singular (e.g. “product”) or plural terms may also include the plural (e.g. “products”) or singular term, respectively. The purchase request may comprise a cash-on-delivery payment option and may originate from a consumer who wishes to purchase one or more products online from a merchant's website. For example, the consumer browses through the merchant's website and wishes to buy a particular product from the merchant. The consumer selects the product he wishes to purchase and adds it to a virtual shopping cart at the merchant's website. After the consumer has finalized his purchase and wishes to checkout, he may select a cash-on-delivery payment option if he wishes to pay in cash upon delivery of the product. The purchase request may further comprise a description of the product, a price of the product and the merchant associated with the product. The transaction module 206, after receiving the purchase request from the merchant module 208, generates a delivery order based on the purchase request.

At step B, the courier module 202 receives the delivery order relating to a delivery of the product to a recipient 210 by a courier service. The delivery order may comprise instructions and/or information (e.g. recipient's address) for the courier service for the delivery of the product to the recipient 210. The courier module 202 may be a mobile/handheld device that is carried by delivery personnel during delivery runs. The courier module 202 may be connected to a central server (not shown in FIG. 2) that is administered by the courier service. The central server can be in communication with multiple courier modules, and can be configured to function as a central processing hub and intermediary between the multiple courier modules and the payment module 204, the transaction module 206 and/or the merchant module 208.

At step C, the courier module 202 receives a delivery status corresponding to an outcome of the delivery of the product to the recipient 210. The delivery status may comprise confirmation by the recipient 210 and the courier service whether delivery of the product is successful or unsuccessful. The delivery status may state that the delivery is “successful” or “unsuccessful” based on the confirmation by both the recipient 210 and the courier service. More specifically, when the product is delivered to the recipient 210, the recipient 210 checks the product. If the recipient 210 is satisfied with the delivered product, he may indicate, by signing on a user interface of the mobile courier device (i.e. courier module 202), acceptance of the product. In another embodiment, the recipient 210 may select “OK” at the user interface of the mobile courier device to indicate acceptance of the product. Other forms of acceptance by the recipient 210 are also possible. Upon acceptance by the recipient 210, the courier service may subsequently select “OK” to indicate acceptance of the product by the recipient 210 (and also successful delivery of the product). In this case, the delivery status is deemed “successful”.

Further at step C, the courier module 202 may receive a payment status corresponding to an outcome of a cash payment for the product by the recipient 210 to the courier service. The payment status may comprise confirmation by the courier service whether payment of the product in cash is successful or unsuccessful. The payment status may state that the payment is “successful” or “unsuccessful” based on the confirmation by the courier service. More specifically, when the product is delivered to the recipient 210, the recipient 210 checks the product. If the recipient 210 is satisfied with the delivered product, he pays the delivery personnel the price of the product in cash. The delivery personnel may indicate, by signing on the user interface of the mobile courier device, successful payment of the product. In another embodiment, the delivery personnel may select “OK” at the user interface of the mobile courier device to indicate successful payment of the product in cash. In this case, the payment status is deemed “successful”.

On the other hand, if the recipient 210 is not satisfied with the product, he may select “NOT OK” on the user interface of the mobile courier device to indicate rejection of the product. The delivery status is therefore “unsuccessful” and the courier module 202 generates an instruction to the payment module 204 to cancel the transaction. In addition, if the recipient 210 did not pay for the product in cash or does not have sufficient cash on hand to pay the courier service, the delivery personnel may select “NOT OK” on the user interface of the mobile courier device to indicate non-payment of the product. The payment status is therefore “unsuccessful” and the courier module 202 generates an instruction to the payment module 204 to cancel the transaction. The courier service then returns the product to the merchant. If the delivery status comprises confirmation of the unsuccessful delivery of the product to the recipient or the payment status comprises confirmation of the unsuccessful cash payment of the product by the recipient, an instruction to cancel the transaction is transmitted to the payment module. In an alternative embodiment, the courier module 202 may generate the instruction to cancel the transaction based on the condition that both the delivery status and the payment status are unsuccessful to mitigate the possibility of fraud by the courier service. For example, if the recipient 210 pays in cash to the delivery personnel but the delivery personnel selects “NOT OK” on the user interface of the mobile courier device to indicate non-payment of the product, the transaction may be cancelled. Therefore, both the delivery status and the payment status must be unsuccessful before the courier module 202 generates the instruction to cancel the transaction.

At step D, if both the delivery status and the payment status of the product are successful, the courier module 202 generates a card-on-file mobile payment instruction for transmission to the payment module 204 to complete the transaction. The card-on-file mobile payment instruction may comprise the price of the product and the merchant associated with product. The payment module 204, upon receiving the card-on-file payment instruction from the courier module 202, generates an instruction to settle the transaction based on the price of the product. For example, the courier service has a particular card-on-file for business to business payment transactions. The card-on-file is associated with the courier service's issuer (Bank ABC). When the courier service determines that the product has been accepted by the recipient 210 and that the recipient 210 has paid in cash for the product (e.g. $300) to the courier service, the courier service instructs the issuer (Bank ABC) to pay the price of the product ($300) from the courier service's account to the merchant to settle the transaction. The merchant thus receives payment for the product ($300).

At step E, the courier module 202 transmits a confirmation message to the merchant module 208 on a condition that the delivery status and the payment status of the product are successful. In other words, the confirmation message is transmitted to the merchant to inform him that the product has been accepted by the recipient 210 and the recipient 210 has paid for the product in cash. The confirmation message may comprise a unique tracking identifier that is associated with the delivery of the product. The confirmation message may also be transmitted after the issuer has paid the merchant to settle the transaction.

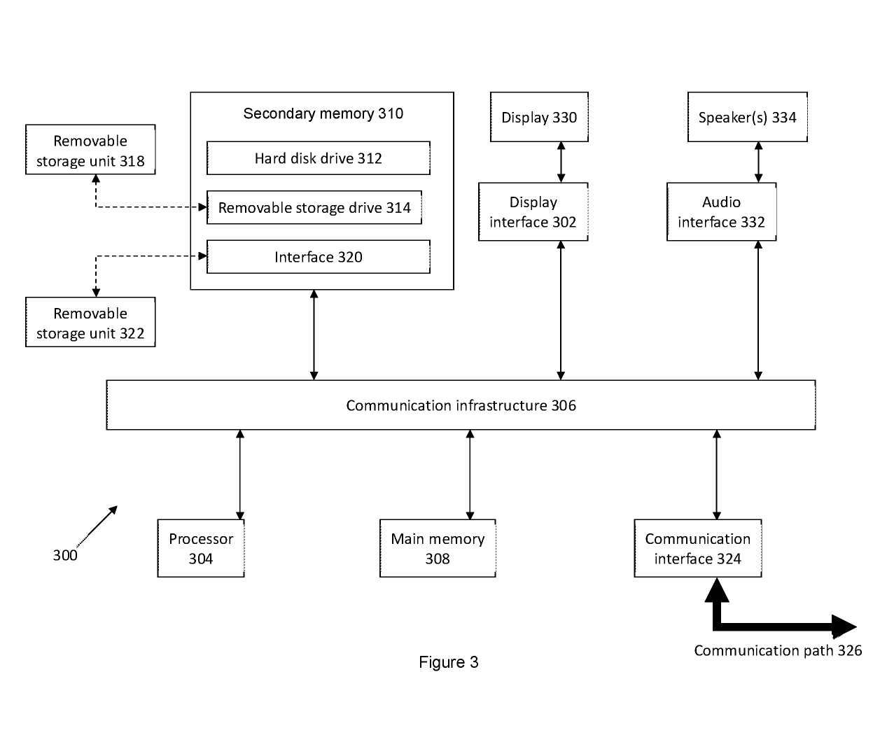

FIG. 3 shows a schematic diagram of a computer device or computer system 300 suitable for realizing the courier module 202, payment module 204, transaction module 206 and/or merchant module 208, according to an example embodiment. The following description of the computing device 300 is provided by way of example only and is not intended to be limiting.

As shown in FIG. 3, the example computing device 300 includes a processor 304 for executing software routines. Although a single processor is shown for the sake of clarity, the computing device 300 may also include a multi-processor system. The processor 304 is connected to a communication infrastructure 306 for communication with other components of the computing device 300. The communication infrastructure 306 may include, for example, a communications bus, cross-bar, or network.

The computing device 300 further includes a main memory 308, such as a random access memory (RAM), and a secondary memory 310. The secondary memory 310 may include, for example, a hard disk drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage unit 318 in a well-known manner. The removable storage unit 318 may include magnetic tape, optical disk, non-volatile memory storage medium, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 320. Examples of a removable storage unit 322 and interface 320 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 320 which allow software and data to be transferred from the removable storage unit 322 to the computer system 300.

The computing device 300 also includes at least one communication interface 324. The communication interface 324 allows software and data to be transferred between computing device 300 and external devices via a communication path 326. In various embodiments, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. Computer readable storage media refers to any non-transitory tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 324. Such computer programs, when executed, enable the computing device 300 to perform one or more features of embodiments discussed herein. In various embodiments, the computer programs, when executed, enable the processor 304 to perform features of the above-described embodiments. Accordingly, such computer programs represent controllers of the computer system 300.

Software may be stored in a computer program product and loaded into the computing device 300 using the removable storage drive 314, the hard disk drive 312, or the interface 320. Alternatively, the computer program product may be downloaded to the computer system 300 over the communications path 326. The software, when executed by the processor 304, causes the computing device 300 to perform functions of embodiments described herein.

It is to be understood that the embodiment of FIG. 3 is presented merely by way of example. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

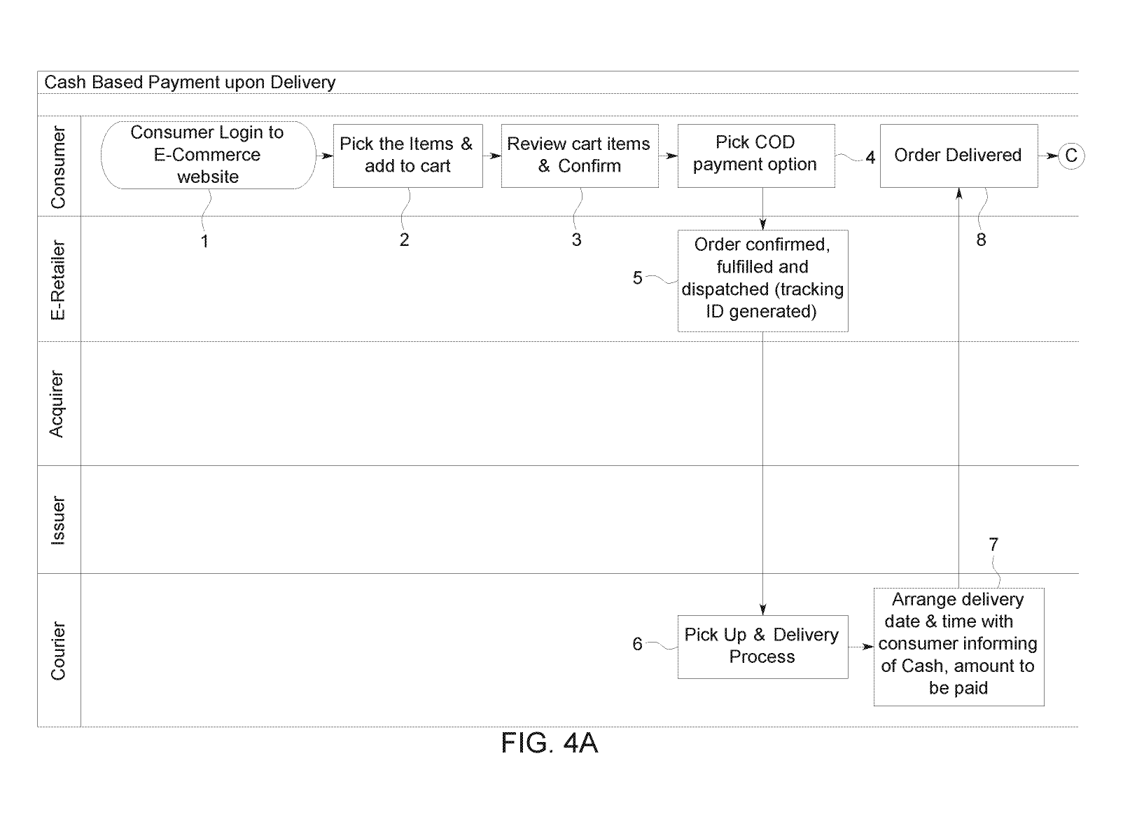

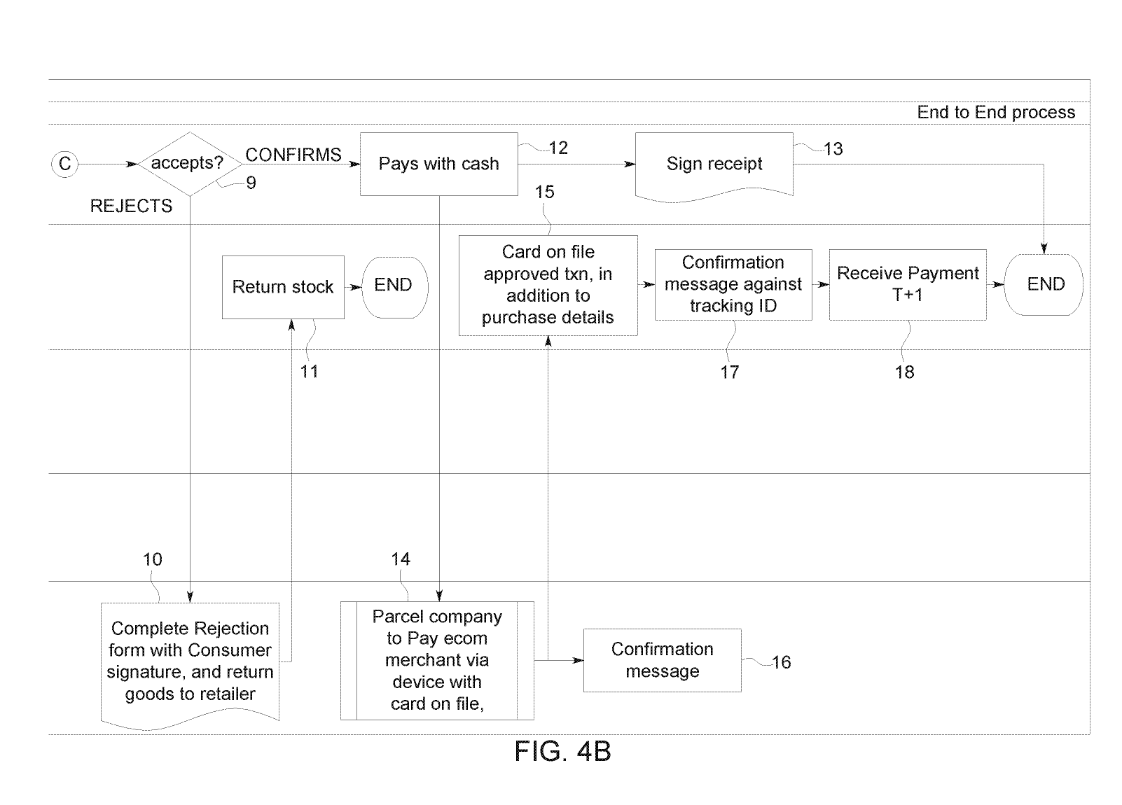

FIG. 4 shows a schematic diagram illustrating the flow of information between various entities during a method for conducting a transaction, according to an example embodiment. At step 1, the consumer logs in to an electronic-commerce website of a merchant. At step 2, the consumer selects the products he wishes to purchase and adds them into the virtual shopping cart at the website. At step 3, the consumer reviews the products in the virtual shopping cart and confirms checkout of the products. At step 4, the consumer selects a cash-on-delivery payment option. At step 5, the merchant confirms that the order is fulfilled and dispatches the products. A unique tracking identifier is also generated at this step for facilitating tracking of the delivery.

At step 6, a courier service picks up the products from the merchant for delivery. At step 7, the courier service arranges a time and date with a recipient for the delivery of the products. The courier service also informs the recipient of a total price of the products to be paid in cash. At step 8, the courier service delivers the products to the recipient. At step 9, the courier service hands over the products to the recipient and the recipient checks to determine if the products delivered are acceptable. At step 10, if the recipient rejects the products, he signs on a rejection form or on a user interface of a mobile courier device provided by the courier service and the courier service returns the products to the merchant. At step 11, the merchant receives the products from the courier service.

On the other hand, if the recipient accepts the products, he pays the courier service the total price of the products in cash at step 12 and signs on the delivery form or on the user interface of a mobile courier device to indicate acceptance of the products at step 13. At step 14, the courier service uses the mobile courier device (having a digital wallet application installed thereon) or an open application programming interface (API) to instruct payment of the total price of the products to the merchant via a card-on-file payment transaction (i.e. a mobile payment transaction). At step 15, the card-on-file payment transaction and purchase details are approved as per known procedures. At step 16, a confirmation message is sent to a central server that is administered by the courier service for monitoring and tracking delivery by its delivery personnel. At step 17, a confirmation message, together with the unique tracking identifier, is sent to the merchant to confirm that the card-on-file payment transaction has been approved and the products have been delivered. At step 18, the merchant receives payment for the transaction at a later time.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for conducting a transaction, comprising:
receiving, at a courier module, a delivery order relating to a delivery of a product to a recipient by a courier service; and
generating, by the courier module, a card-on-file mobile payment instruction for transmission to a payment module to complete the transaction based on:
(i) a delivery status corresponding to an outcome of the delivery of the product to the recipient; and
(ii) a payment status corresponding to an outcome of a cash payment for the product by the recipient to the courier service.

2. The method as claimed in claim 1, the method further comprising:
(i) receiving, at a transaction module that is in communication with the courier module, a purchase request for the product; and
(ii) generating, at the transaction module, the delivery order based on the purchase request.

3. The method as claimed in claim 2, wherein the card-on-file mobile payment instruction comprises a price of the product and a merchant associated with the product.

4. The method as claimed in claim 3, wherein the purchase request comprises one or more of: a description of the product, the price of the product, the merchant associated with the product and a cash-on-delivery payment option.

5. The method as claimed in claim 1, wherein the delivery status comprises confirmation, by the recipient, of a successful or unsuccessful delivery of the product to the recipient.

6. The method as claimed in claim 5, wherein the payment status comprises confirmation, by the courier service, of a successful or unsuccessful cash payment of the product by the recipient.

7. The method as claimed in claim 6, wherein the card-on-file mobile payment instruction to complete the transaction is transmitted to the payment module on a condition that:
(i) the delivery status comprises confirmation of the successful delivery of the product to the recipient; and
(ii) the payment status comprises confirmation of the successful cash payment of the product by the recipient.

8. The method as claimed in claim 6, wherein an instruction to cancel the transaction is transmitted to the payment module on a condition that:
(i) the delivery status comprises confirmation of the unsuccessful delivery of the product to the recipient; or
(ii) the payment status comprises confirmation of the unsuccessful cash payment of the product by the recipient.

9. The method as claimed in claim 3, wherein completing the transaction comprises generating, by the payment module, an instruction to settle the transaction based on the price of the product.

10. The method as claimed in claim 1, the method further comprising:
(i) generating a unique tracking identifier associated with the delivery of the product to the recipient; and
(ii) transmitting, to a merchant module in communication with the courier module, a confirmation message on a condition that:
(i) the delivery status comprises confirmation of a successful delivery of the product to the recipient; and
(ii) the payment status comprises confirmation of a successful cash payment of the product by the recipient,
wherein the confirmation message comprises the unique tracking identifier.

11. A system for conducting a transaction, comprising a courier module, the courier module comprising:
at least one processor; and
at least one memory including computer program code;
the at least one memory and the computer program code configured to, with at least one processor, cause the courier module at least to:
receive a delivery order relating to a delivery of a product to a recipient by a courier service; and
generate a card-on-file mobile payment instruction for transmission to a payment module to complete the transaction based on:
(i) a delivery status corresponding to an outcome of the delivery of the product to the recipient; and
(ii) a payment status corresponding to an outcome of a cash payment for the product by the recipient to the courier service.

12. The system as claimed in claim 11, further comprising a transaction module that is in communication with the courier module, wherein the transaction module is configured to:
(i) receive a purchase request for a product; and
(ii) generate the delivery order based on the purchase request.

13. The system as claimed in claim 12, wherein the card-on-file mobile payment instruction comprises a price of the product and a merchant associated with the product.

14. The system as claimed in claim 13, wherein the purchase request comprises one or more of: a description of the product, the price of the product, the merchant associated with the product and a cash-on-delivery payment option.

15. The system as claimed in claim 13, wherein the payment module is configured to generate an instruction to settle the transaction based on the price of the product.

16. The system as claimed in claim 11, wherein the delivery status comprises confirmation, by the recipient, of a successful or unsuccessful delivery of the product to the recipient.

17. The system as claimed in claim 16, wherein the payment status comprises confirmation, by the courier service, of a successful or unsuccessful cash payment of the product by the recipient.

18. The system as claimed in claim 17, wherein the card-on-file mobile payment instruction to complete the transaction is transmitted to the payment module on a condition that:
(i) the delivery status comprises confirmation of the successful delivery of the product to the recipient; and
(ii) the payment status comprises confirmation of the successful cash payment of the product by the recipient.

19. The system as claimed in claim 18, wherein an instruction to cancel the transaction is transmitted to the payment module on a condition that:
(i) the delivery status comprises confirmation of the unsuccessful delivery of the product to the recipient; or
(ii) the payment status comprises confirmation of the unsuccessful cash payment of the product by the recipient.

20. One or more computer storage media having computer-executable instructions for conducting a transaction that, upon execution by a processor, cause the processor to at least:
receive, at a courier module, a delivery order relating to a delivery of a product to a recipient by a courier service; and
generate, by the courier module, a card-on-file mobile payment instruction for transmission to a payment module to complete the transaction based on:
(i) a delivery status corresponding to an outcome of the delivery of the product to the recipient; and
(ii) a payment status corresponding to an outcome of a cash payment for the product by the recipient to the courier service.
